(19) United States
(12) Patent Application Publication
(10) Pub. No.: US 2007/0050212 A1
(43) Pub. Date: Mar. 1, 2007

(54) Secure telerehabilitation system and method of use

(75) Inventors: Gerald W. Kearby, Loma Mar, CA (US); Earl I. Levine, Palo Alto, CA (US); A. Robert Modeste, Redwood City, CA (US)

Correspondence Address: LEVINE BAGADE HAN LLP, 2483 EAST BAYSHORE ROAD, SUITE 100, PALO ALTO, CA, 94303, US

(73) Assignee: NeuroTone, Inc., Redwood City, CA (US)

(21) Appl. No.: 11/198,713

(22) Filed: Aug. 5, 2005

(51) Int. Cl. G06F 19/00; G06Q 99/00

(52) U.S. Cl. 705/3; 705/51

(57) ABSTRACT

A system and method for secure telerehabilitation is disclosed. The system and method can create results to evaluate patient performance. The results can then be uploaded to a server and stored in a database. The database can have secure fields for each doctor and secure fields for each patient within each doctor's field. The

### BACKGROUND OF THE INVENTION

1. Field of the Invention

The present invention relates generally to a system for secure creation, transmission, storage and retrieval of private data, such as patient-specific data for telerehabilitation and/or therapy, and a method of using the same.

2. Description of the Related Art

Use of the internet to facilitate medical therapy and patient training and rehabilitation has grown significantly and, largely as a result, transmission of patient data over public computer networks and in publicly accessible databases has increased. The Health Insurance Portability and Accountability Act of 1996 (HIPAA) sets forth requirements regarding security and privacy of patient information. In order to aid in compliance, systems dealing with patient information must secure data, limiting access to patients and doctors.

Yet some of the data generated by these systems is beneficial for health research purposes. Also, organizations managing the medical therapy and patient training and rehabilitation systems also need access to some of the data both to administer the systems and to make improvements in the present and future generations of these products.

Therefore, there exists a need for a secure system and method of storing, rehabilitation system and a method of using the same. There also exists a need for a secure system and method that creates selective access to data

### BRIEF SUMMARY OF THE INVENTION

A secure telerehabilitation system and method of use is disclosed herein. The system can be used for aural rehabilitation and training, among other medical, educational and rehabilitation purposes. The system can have a patient's device and a server, wherein the patient's device is securely networked with the server. The system can also have a doctor's device, wherein the doctor's device is securely networked with the server. The patient's device can be configured to create a set of results, such as a log or score. The results can be uploaded to the server.

A method of aural telerehabilitation for a subject includes uploading the results to a server and encrypting the results. Before uploading, the results can be calculated using a patient's device. The method can also include storing the results in a database. The server can have the database. The results can be stored in a physician's secure account within the database. The results can be stored in a patient's record within the physician's account.

A method of securely distributing telerehabilitation software to a user is also disclosed. The method includes delivering the telerehabilitation software to a distributor, reserving a license for the telerehabilitation software, delivering the telerehabilitation software to the user, and activating the telerehabilitation software, wherein the user prompts the activation.

### BRIEF DESCRIPTION OF THE DRAWINGS

FIG. 1 illustrates an embodiment of the telerehabilitation system.

FIG. 2 illustrates an embodiment of a method of distributing and enabling the patient's telerehabilitation software.

FIG. 3 illustrates an embodiment of a method of using the telerehabilitation system.

FIG. 4 illustrates an embodiment of a method of initializing a physician account.

FIG. 5 illustrates an embodiment of a method of logging into the physician account.

FIG. 6 illustrates an embodiment of a method of initializing a patient account.

FIG. 7 illustrates an embodiment of a method of uploading patient logs.

FIG. 8 illustrates and embodiment of a method for patient records transfer.

FIG. 9 illustrates an embodiment of the patient's device's software architecture.

### DETAILED DESCRIPTION

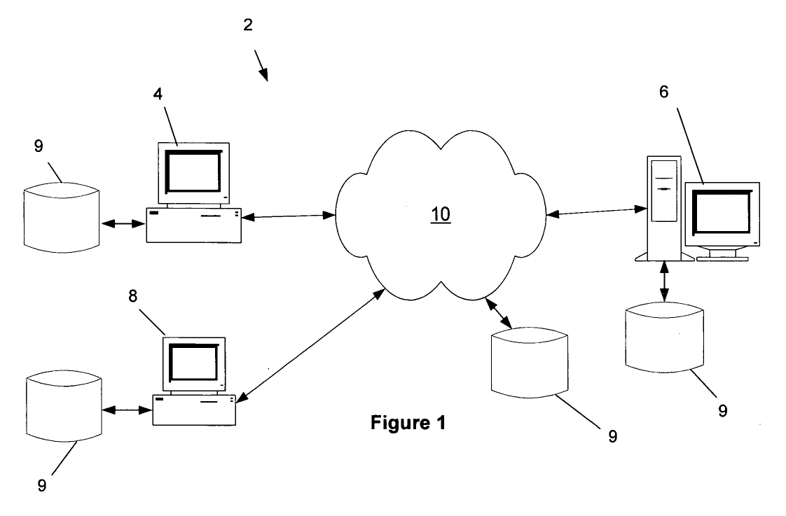

FIG. 1 illustrates a system 2 for medical rehabilitation, treatment, training or other teaching, such as neurological (e.g., aural, tinnitus, autistic), muscular (e.g., voluntary and/or involuntary), rehabilitation, treatment, training or other teaching, can have an electronics hardware platform and/or software programs. The conditions that can be treated can include any neurological process amenable to treatment or augmentation by media, such as video for neural rehabilitation and/or sound for aural rehabilitation (e.g., hearing air training or rehabilitation) or otological or audiological disorders such as tinnitus or other pathologies where retraining of the auditory cortex using auditory stimulus and/or training protocols to improve function is possible. Other examples include refining or training substantially physiologically normal hearing, stuttering, autism or combinations thereof. The system 2 can also be used, for example, for phoneme training (e.g., in children or adults), foreign language training, free space sound source identification and spatial localization, hazardous and battlefield environment training, sonar operator training and hearing aid parameter determination testing.

Examples of the hardware and software platforms, and examples of devices, systems and methods for providing diagnosis and therapy for audiological diseases are described in U.S. patent application Serial Nos. 10/790,319, filed 1 Mar. 2004; Ser. No. 11/151,820, filed 13 Jun. 2005; and Ser. No. 11/151,873, filed 13 Jun. 2005, all of which are incorporated by reference herein in their entireties. The hardware systems can execute telerehabilitation software 12 that can instruct, perform, score, such as by recording user gestures and log results of rehabilitation, and can be delivered and/or controlled, and/or report results over a network (e.g., the internet).

The treatment herein can include augmentation and/or diagnosis and/or therapy. The condition that can be treated can be any neurological process amenable to treatment or augmentation by sound, for example otological or audiological disorders such as hearing loss or other pathologies where retraining of the auditory cortex using auditory stimulus and/or training protocols to improve function is possible. Other examples of treatment of audiological conditions include refining or training substantially physiologically normal hearing, tinnitus, stuttering, autism or combinations thereof.

The system 2 can have a physician's device 4, a remote device, such as a server 6, and a local device, such as patient's device 8. The physician's device 4, the server 6 and the patient's device 8 can be in communication with a network 10, such as a local area network (LAN) and/or the internet. The physician's device 4, server 6 and patient's device 8 can be configured to be in one-way and/or two-way communication with each other.

The physician's device 4, the server 6 and the patient's device 8 can be, for example, laptop or desktop personal computers (PCs), personal data assistants (PDAs), network servers, portable (e.g., cellular, cordless) telephones, portable audio players and recorders (e.g., mp3 players, voice recorders), car or home audio equipment, thin client devices (e.g., MSNTV2 by Microsoft, WebTV), home digital video recorders (e.g., Tivo, ReplayTV), cable or satellite decoder devices, home learning/teaching devices (e.g., Pixter by Fisher Price), game playing devices (e.g., Sony PlayStation I, II, II, PlayStation Portable, Microsoft Xbox, Nintendo GameBoy), medical monitoring device (e.g., Health Buddy by Health Hero Network, Inc, Mountain View, Calif.) or combinations thereof. The physician's device 4, the server 6 and the patient's device 8 can be processors connected on the same circuit board, components of the same processor, or combinations thereof and/or combinations with the examples herein. The physician's device 4, the server 6 and the patient's device 8, or any combination thereof, can be a single device of any example listed herein, for example a single PC or a single, integrated processor. The physician's device 4, the server 6 and the patient's device 8, or any combination thereof, can be multiple devices of any example listed herein, for example two PCs or two processors on the same circuit board. The physician's device 4, the server 6 and the patient's device 8, or any combination thereof, can have and/or utilize a graphic user interface (GUI) operating system (OS) PDA (e.g., the Yopy 500 from G. Mate, Inc., Kyounggi-Do, Korea). The physician's device 4, the server 6 and the patient's device 8, or any combination thereof, can have and/or utilize any Microsoft Windows OS, any Apple OS, any Linux OS or any FreeBSD OS.

The server 6 can have a database 9. The database 9 can be stored on the doctor's device 4, the patient's device 8, or elsewhere. The database 9 can be structured file formats, relational (e.g., Structured Query Language types, such as SQL, SQL1 and SQL2), object-oriented (e.g., Object Data Management Group standard types, such as ODMG-1.0 and ODMG-2.0), object-relational (e.g., SQL3), or multiple databases 9 of one or multiple types. The database 9 can be a single set of data. The database 9 can be or comprise one or more functions.

The communications can be via hardwiring (e.g., between two processors or integrated circuit devices on a circuit board), transferable media (e.g., CD, floppy disk, removable flash memory device, SIM card, a smart card, USB based mass storage device), networked connection (e.g., over the internet, Ethernet (IEEE 802.3), universal serial bus (USB), Firewire (IEEE 1394), 802.11 (wireless LAN), Bluetooth, cellular communication modem), direct point-to-point connection (e.g., serial port (RS-232, RS-485), parallel port (IEEE 1284), Fiber Channel, IRDA infrared data port, modem, radio such as 900 MHz, 2.4 GHz, 5.8 GHz RF, unlicensed RF bands or FM signal) or combinations thereof. The communications can be constant or sporadic.

The physician's device 4 can have local memory. The memory can be non-volatile, for example a hard drive or non-volatile semiconductor memory (e.g., flash, ferromagnetic). A copy of all or part of the database 9 can be on the local memory of the physician's device 4. The physician's device 4 can be configured to communicate with the database 9 through the server 6.

The server 6 can be configured to transfer data to and from the physician's device 4, the patient's device 8 and/or the database 9. The data transfer can be through a port (e.g., USB, Firewire, serial, parallel, Ethernet), a media player and/or recorder (e.g., CD drive, floppy disk drive, smart card reader/writer, SIM card, flash memory card reader/writer (e.g., Compact Flash, SD, Memory Stick, Smart Media, MMC), USB based mass storage device), a radio (e.g., Bluetooth, 802.11, cellular or cordless telephone, or radio operating at frequencies and modulations such as 900 Mhz or commercial FM signals) or combinations thereof.

Data stored in the database 9 can include all or any combination of the data found in patient profiles, profile assessment data, relevant assessment data, execution therapy reports, recommended therapy reports, physician's therapy reports, executed session reports, analyzed session reports, user gesture log, scoring data, results logs, user response data, registration data. The reports can be compressed and decompressed and/or encrypted and decrypted at any point during the methods described herein. The reports can be script, XML, binary, executable object, text files and composites of combinations thereof.

The server 6 can have internet protocol (IP) traffic restrictions. For example, the IP restrictions can be set to allow only the physician's device 4 and/or the patient's device 8 (or multiple patients' devices) to access the server 6. The server 6 can host a website, for example through which the database can be accessed. The server 6 can be located in a secure web hosting facility. For example, the server 6 can be secured within a locked cage.

The server 6 can execute a central server application 15. The central server application 15 cab be software that can access, for example read from and/or write to, the database 9 and/or perform administration and/or electronic commerce functions. The central server application 15 can be configured to allow access by a limited number of users, for example no more than three users. Each user can have a central server application password. The central server application passwords can be configured to expire automatically at a specific time interval, such as monthly. The users can register new central server application passwords when old central server application passwords expire.

The central server application 15 can have administration functions for outputting a list of valid physician's accounts, status of physician's accounts, purchase history and records. The central server application 15 can have administration functions for editing physican's accounts. The central server application's editing functions can allow for the updating of physician account information such as billing address and shipping address, the addition or revocation of telerehabilitation software licenses in a physician's account. The central server application 15 can have administration functions for connecting to financial and accounting systems (e.g., QuickBooks by Intuit Inc., Mountain View, Calif.). The central server application 15 can have administration functions for printing license stickers, fulfillment of physician purchases, connections to shipping systems (e.g., for United Parcel Service of America, Inc., Atlanta, Ga. or FedEx Corp., Memphis, Tenn.). The central server application 15 can have functions for connecting to credit card processing systems (e.g., those of Electronic Merchant Systems, Cleveland, OH) to allow the physician to purchase telerehabilitation software 12 and/or registration licenses for the telerehabilitation software 12 and/or other merchandise.

When the server 6 receives a security update, for example from an external security update service (e.g., Norton, McAfee), the server 6 can be configured to wait a specific update delay (e.g., 24 hours) before implementing the security update. The server 6, for example automatically or manually, can abort the security update before implementing the security update. The server 6 can complete security updates within about four days of receipt of the security update. The server 6 can be backed up on a daily basis.

If the physician's device 4 and/or the patient's device 8, and/or another device, is accessing the server 6 in a session and the session is idle for a specific period of time (e.g., about five minutes), then the session can be automatically logged off by the server. The server 6 can automatically refresh the physician's device's screen and/or the patient's device's screen when the session is logged off. The server 6 can be configured to prevent caching of web pages on the server by the physician's device's screen and/or the patient's device's. The server 6 can be configured to back up all or one or more portions of the data on the server 6. For example, the data can be backed up to a back-up server networked with the server 6.

The server 6 can use an encryption key size of at least 128 bits for any transmission through the network, and/or for storing data in the database 9. The server 6 can use an encryption algorithm such as an Advanced Encryption Standard (AES). The server 6 can use a hashing algorithm such as SHA-1 (Secure Hashing Algorithm).

The server 6 can create and store an access log each time the database 9 is accessed. The server 6 can store the access logs for a minimum time period, for example about six years, after each access log's creation.

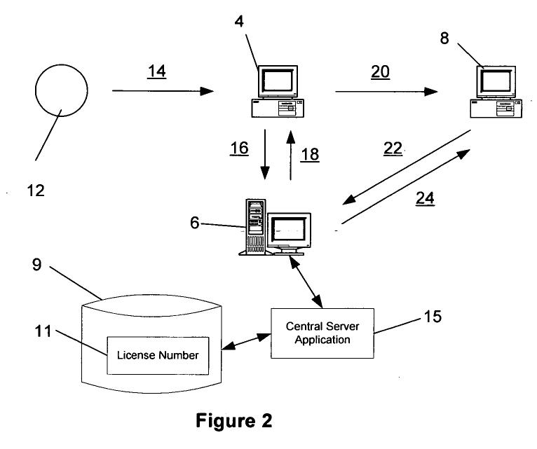

FIG. 2 illustrates that a copy of a patient's telerehabilitation software 12 can be sent, as shown by arrow 14, to the physician and/or the physician's device 4. The telerehabilitation software 12 can be sent with a license number (e.g., an alphabetic, numeric, alphanumeric, binary, and/or otherwise symbolic code). The license number can be separate and unattached from the copy of the patient's telerehabilitation software 12. The license number can be sent electronically or in print. The patient's telerehabilitation software 12 can be on a media, such as a CD, DVD, flash memory device, floppy disk, hard disk, downloaded over the network 10, or combinations thereof. The physician and/or physician's device 4 can make new copies of the patient's telerehabilitation software 12 onto new media, such as the media listed supra, including hard drives.

The physician and/or the physician's device 4 can then send a request for reserving the license number as shown by arrow 16, for example coupled with a registration payment, to the telerehabilitation service provider and/or the server 6. If the telerehabilitation service provider and/or server 6 determine that the request for registration is valid (e.g., not previously registered, sufficient payment is sent, the license number was previously sent to the physician), the telerehabilitation service provider and/or server 6 can reserve the license number in the database 9. The telerehabilitation service provider and/or server 6 can notify, as shown by arrow 18, the physician and/or the physician's device 4, that the license number was or was not registered and/or reserved. Functional telerehabilitation features of the telerehabilitation software 12 can be configured to not be executable until the license number is reserved.

The physician and/or physician's device 4 can send, as shown by arrow 20, the telerehabilitation software 12 and one reserved license number for each copy of the telerehabilitation software 12 to the patient and/or patient's device 8. The patient and/or the patient's device 8 can then register and/or activate the telerehabilitation software 12, for example, by sending, as shown by arrow 22, a request to register and/or activate the license number to the telerehabilitation service provider and/or the server 6. The functional telerehabilitation features of the registered and/or activated telerehabilitation software 12 can then be executed by the patient's device 8.

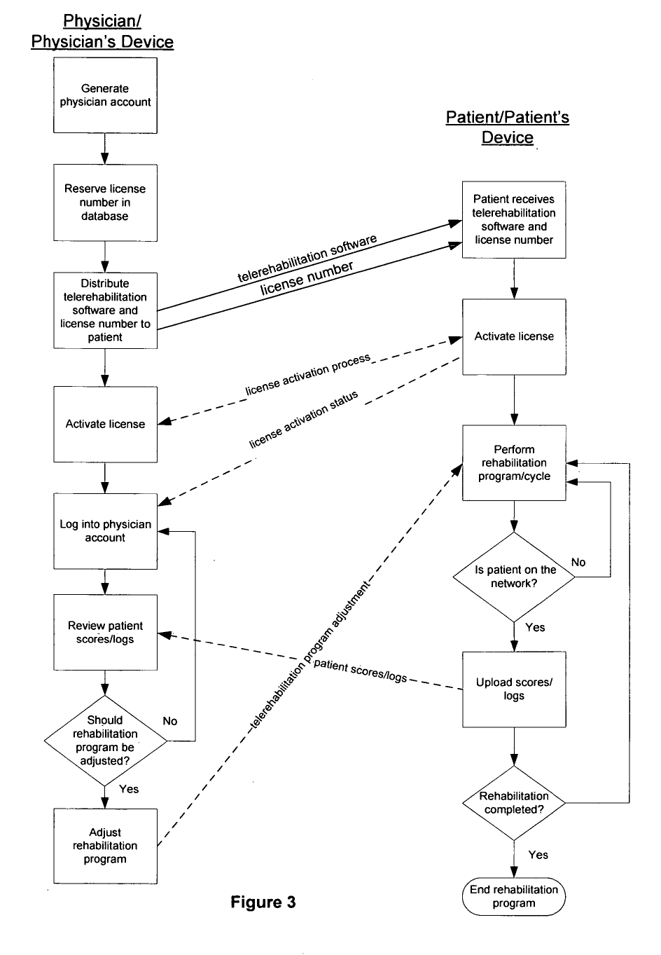

FIG. 3 illustrates that the physician can generate a physician account. The phantom lines in FIG. 3 illustrate data transfer, for example over the network 10. The physician account can hold rehabilitation results from one or more patients. The physician can generate a physician account. The physician account can be a field and/or group of fields and/or object and/or group of objects in the database 9.

The physician can reserve the license number and send or otherwise distribute the telerehabilitation software 12 to the patient, as described supra. After the physician has reserved the license number, the patient and/or the physician can register and/or activate the license number. Activating and/or registering the license number can create a patient field or object in the database 9 specific to that patient. The patient can then perform rehabilitation via the telerehabilitation software 12.

After at least one cycle, class or program of use of the telerehabilitation software 12, the patient and/or physician can manually or automatically upload results and/or logs of the patient's performance from the telerehabilitation software 12 from the patient's device 8 to the database 9 and/or the physician's device 4. The patient can then continue telerehabilitation until the telerehabilitation is complete. The telerehabilitation can be completed when decided by the physician, patient and/or the telerehabilitation software 12.

At any time after the physician account is generated, the physician can log in to the physician account. When logged into the physician account, the physician can review the license activation status, the patient results and/or logs and/or any other patient or normative result data for population groups (e.g., in the database 9). The physician and/or the rehabilitation software 12 can decide that the rehabilitation program should be adjusted, for example based on the patient results and/or logs and/or any other patient or normative result data for population groups. If the physician and/or telerehabilitation software 12 adjusts the rehabilitation program, the adjustments can be sent over the network 10 to the patient's device 8.

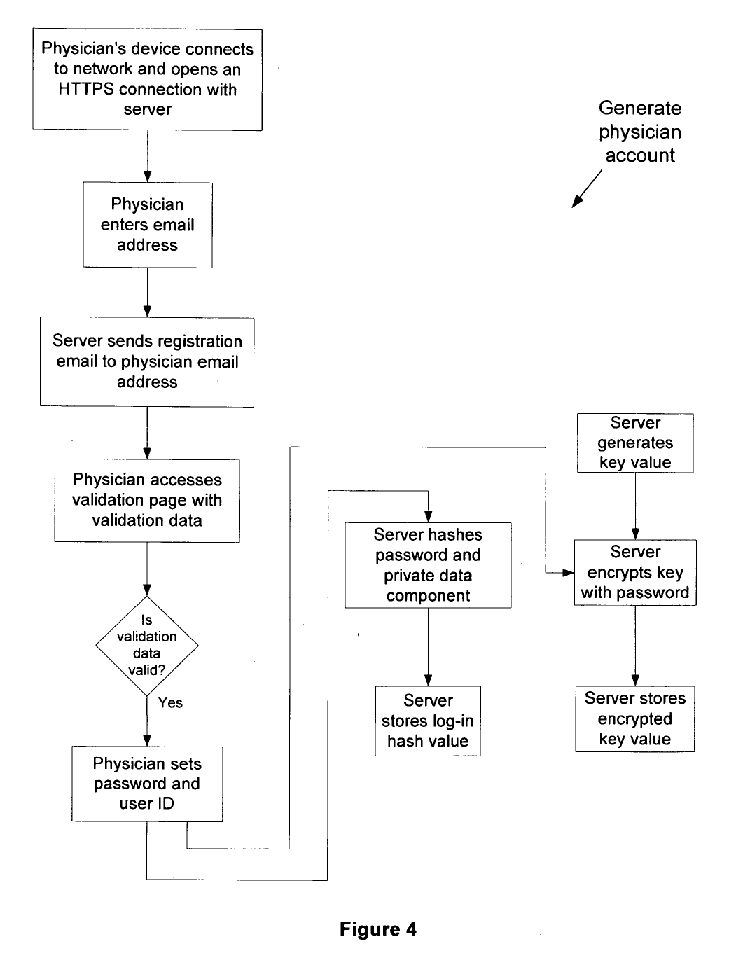

FIG. 4 illustrates a method of generating the physician account. The physician's device 4 can connect to the network 10 and open a connection to the server 6 under a secure authenticated protocol such as HTTPS. The physician can enter a physician email address at the website hosted by the server 6. The server 6 can send a validation email to the physician email address. The validation email can contain validation data, such as an expiration time (e.g., five minutes) and a physician validation digital signature, and a link to a validation page of the website. The link to the validation page of the website can contain the validation data. The physician validation digital signature can be configured from the physician email address and the expiration time and the physician validation private key.

The physician validation digital signature can be a public private digital signature algorithm, for example Digital Signature Standard (DSS) as shown in Federal Information Processing Standards publication (FIPS PUB) 186. The server 6 can have the physician validation private key and the public key or the public key and private keys may each be on separate devices that comprise the server 6.

Upon receipt of the validation email, the physician can click the link and arrive at the validation page. The server 6 can validate the validation data. For example, to be valid, the physician's digital signature can validated using the physician validation public key and whose output must match the expected digital signature and the expiration time can be non-expired. If the validation data is valid, the physician can set a password and set a user ID in the database 9 (e.g., in the object or field for the physician) on the server 6, for example via the website. The user ID can be pre-set as the physician email address and/or a unique physician ID number can be assigned. The unique physician ID can randomly and/or pseudo-randomly and/or sequentially generated.

The password, user ID and a private data component can be hashed together, for example to produce a log-in hash value. The private data component can be pre-set by and/or in the server 6. The hashing can be performed using the SHA1 algorithm. The log-in hash value can be stored and associated with the user ID, for example in the database 9, such as within the physician account object or field.

In another method of account validation, the physician can enter a physician email address at the website hosted by the server 6. The server 6 can generate a random token (e.g. 128 bits). The server 6 can send a validation email to the physician's email address. The validation email can contain a link to a validation page of the website. The link can contain the random token.

Upon receipt of the validation email, the physician can click the link and arrive at the validation page. The server 6 can extract the random token. The server 6 can use the random token to retrieve the validation data. The server 6 can then validate the validation data as explained supra.

The server 6 can generate a patient data key value (e.g., a 128 bit key value). The patient data key value can be unique for each patient. The server can generate a unique physician data public/private key pair. The physician data public/private cipher can be a Rivest Shamir Adelman (RSA) algorithm. The physician data public/private key pair can be 512 bits in length. The server 6 can encrypt the physician data private key value with the password and/or the user ID and/or a private data component (i.e., the same or different private data component as described supra) supplied by the server 6, creating an encrypted physician data private key value. The physician data private key can be encrypted with a cipher such as Password Based Encryption (PBE) with MD-5 and DES. The method used to generate the key used to encrypt the physician data private key can be the PBE with SHA-1 and Two-Fish CBC. The encrypted physician data private key value can be stored in the database 9. All encryption can use a minimum of 128 bit key lengths. The server 6 can use the physician data public key to encrypt each unique patient data key. The server 6 can store each unique encrypted patient data key in the database 9. The physician's patient records are encrypted using the unique patient data key stored in the database 9. The patient records can be encrypted with a cipher such as the Advanced Encryption Standard (AES). The server 6 can use the decrypted physician data private key to decrypt the unique patient key to decrypt patient data records in the database 9.

The server can be configured to not store the user password or the decrypted physician data private key value in the database 9, and/or elsewhere. If the user password is lost, the physician can re-enter private patient data into the database 9.

A third party (i.e., other than the telerehabilitation service provider, physician or patient) can hold the password in escrow. The server 6 can automatically send the password to a secure password escrow facility.

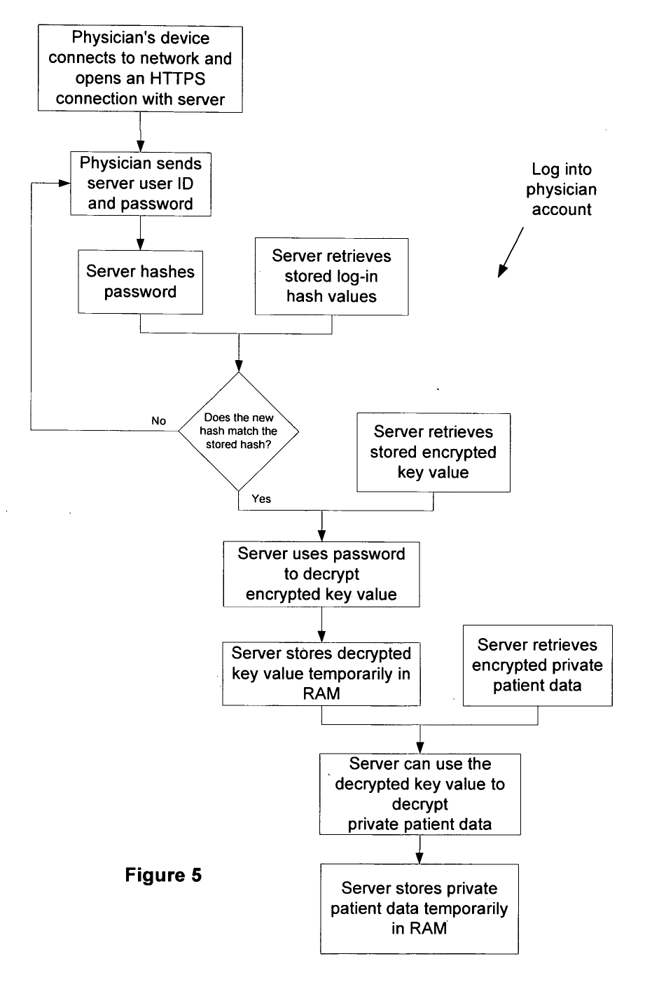

FIG. 5 illustrates a method of logging on to the physician account. The physician's device 4 can connect to the network 10 and open a connection to the server 6 under a secure authenticated protocol such as HTTPS. The physician can send his or her user ID and password to the server 6, for example using HTTPS. The server 6 can hash the newly entered password, the user ID and the private data component described supra to create a log-in hash comparison value. The server 6 can use the user ID to locate and retrieve the stored log-in hash value in the database 9. The server 6 can compare the stored log-in hash value to the newly created log-in comparison value. If the log-in hash value matches the newly created log-in comparison value then the server 6 can grant the physician entry to the physician account.

If the log-in hash value does not match the newly created log-in comparison value, the server 6 can redirect the physician to the log-in page to re-enter the user ID and password. The server 6 can limit the number of log-in re-entry attempts, for example to three attempts.

The server 6 can retrieve the encrypted physician data private key value from the database 9 using the user ID. Once the server 6 grants the physician entry into the physician account, the server 6 can use the password and private data to decrypt the encrypted physician data private key value. The server 6 can store the decrypted physician data private key value temporarily in RAM. The decrypted physician data private key is used to decrypt each unique encrypted patient data key. The decrypted patient data keys are temporarily stored in RAM.

The server 6 can retrieve all or part of encrypted patient data from the database 9. The server can decrypt each encrypted patient data with the corresponding unique decrypted patient data key value. The server 6 can store all or part of the decrypted patient data temporarily in RAM.

The server 6 can delete all or part of the decrypted key values and/or all or part of the decrypted private patient data and/or the decrypted physician data private key from RAM after the physician uploads the patient data and/or when the physician logs off or is logged off the physician account by the server 6.

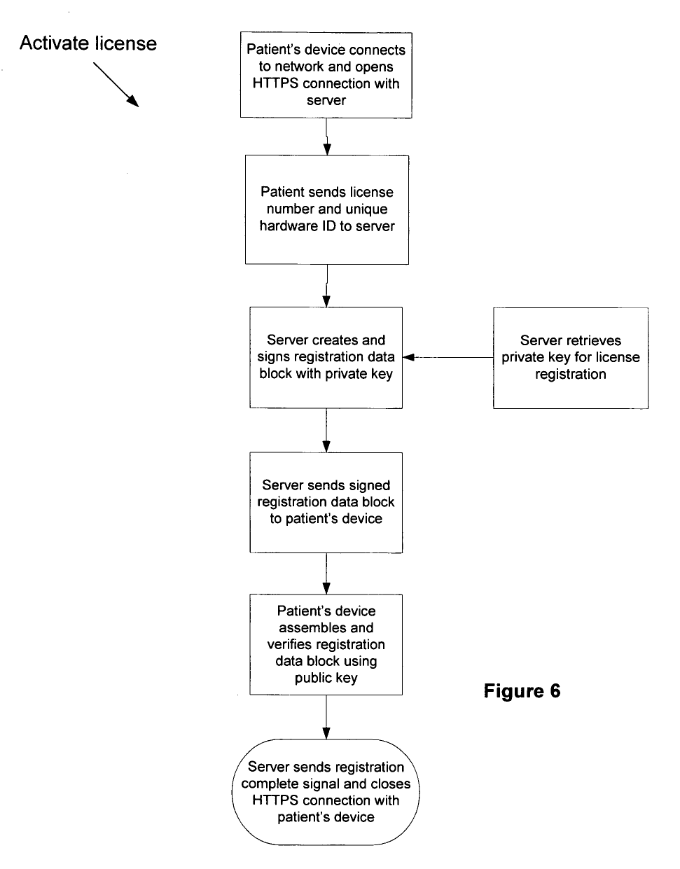

FIG. 6 illustrates a method of activating the license. The patient's device 8 can connect to the server 6, for example via the network 10. The connection can not be a secure authenticated connection, such as the HTTPS protocol.

The patient's device 8 can then send the license number for the telerehabilitation software 12 and a unique hardware ID (i.e., unique machine ID) to the server. Unique hardware IDs are known to those having ordinary skill in the art. The telerehabilitation software 12 can generate the unique hardware ID from data specific the patient's device 8. The unique hardware ID can uniquely identify the patient's device 8 from any other device. The server 6 can associate the license number and unique hardware ID with the patient's record and store this data.

There can be a license activation public/private key pair as part of a digital signature process such as DSS. The license activation public/private key pair can be, for example, 256, 384, 512, 768, or 1024 bits in length. The server 6 can retrieve the license activation private key which is designated for use solely with the telerehabilitation software license activation process. The license activation private key may or may not be encrypted. The license activation private key is located only on the server 6 and the license activation public key is embedded within the patient telerehabilitation software 12.

The server 6 can generate a registration data block. The registration data block can be made from the license number, the unique hardware ID, a serial number of the license number and/or of the telerehabilitation software 12, a license version of the telerehabilitation software 12, an expiration date of the license number, or combinations thereof.

The server 6 can then create a license activation digital signature by signing the registration data block using the license activation private key. The server 6 can then send to the patient's device 8 the license activation digital signature, and the serial number, the license version and the expiration date.

The patient's device 8 can then assemble the registration data block and verify the license activation digital signature using the public key embedded in the telerehabilitation software 12. If the license activation digital signature verifies then the telerehabilitation software 12 is activated. If the telerehabilitation software 12 is activated, the telerehabilitation software 12 can allow itself to run on the patient's device 8. If the license activation digital signature does not verify, then the telerehabilitation software 12 does not activate. If the telerehabilitation software 12 is not activated, the telerehabilitation software 12 can disallow itself to run on the patient's device 8. The license activation digital signature, the license number, the serial number, the license version and expiration date can be stored on the patient's device 8.

After activation of the telerehabilitation software 12, the server 6 can send a registration complete signal to the patient's device 8 and close the HTTPS connection with the patient's device 8.

Each subsequent occasion that the telerehabilitation software 12 is executed the unique machine ID can be calculated and used to validate the stored registration data block as described supra. If the stored registration data block correctly validates then the telerehabilitation software 12 can continue in the current rehabilitation session. If the stored registration data block does not validate, then the telerehabilitation software 12 can end its current session.

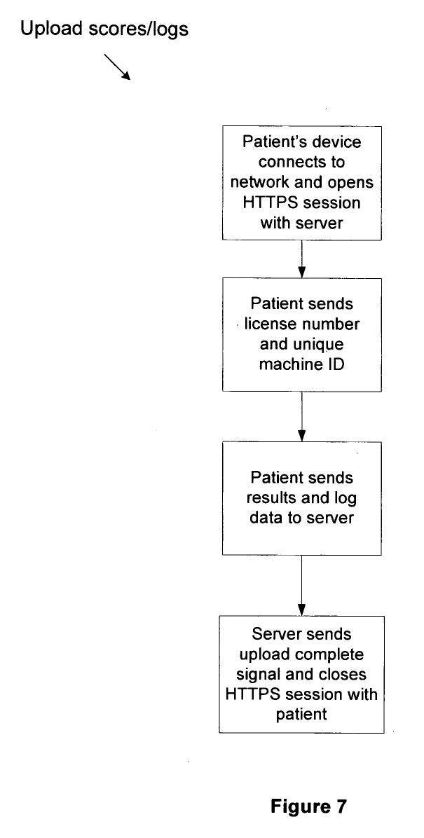

FIG. 7 illustrates the result and log uploading from the patient device 8 to the database 9 on or in communication with the server 6. The patient's device 8 can connect to the server 6, for example with or without a secure authenticated protocol such as HTTPS via the network 10. The patient's device 8 can then send the license number and unique machine ID to the server 6. The server 6 can identify the patient's account with the license number. The server 6 can confirm the patient's device's identity, for example comparing the unique machine ID with the unique machine ID in the patient's record in the database 9.

The server 6 can send updates regarding the patient results to the patient and/or the physician. For example, the server 6 can send updates based on the patient results compared to the demographically equivalent results in the database 9, and/or based on the physician's changes, and/or the changes in the default training, and/or based on specifications for hearing aids or other assistive devices.

The database 9 can store one or more public fields for each patient. For example, for telerehabilitation software 12, fields in the database 9 could record whether the hearing aid was returned by the patient to the distributor and/or manufacturer, HHIE scores, QuickSin score, hearing threshold values, HINT score, age, gender, word recognitions scores, hearing aid experience, office record ID.

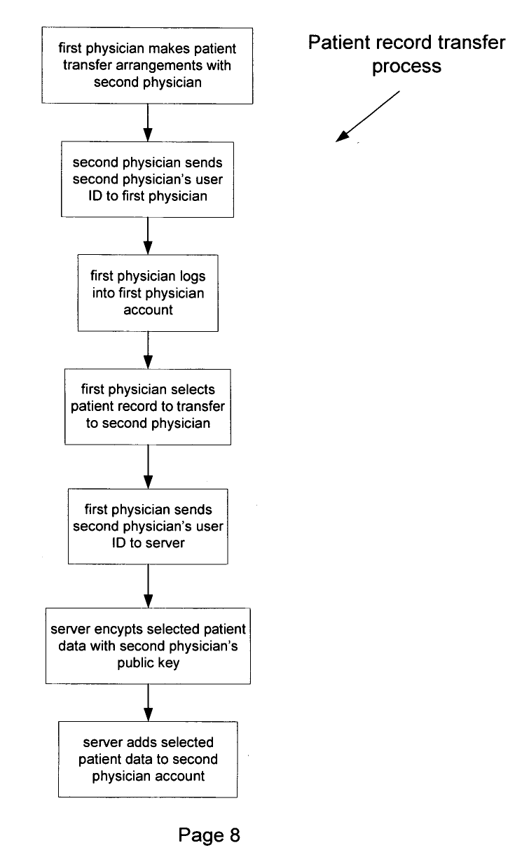

FIG. 8 illustrates a method of a first physician transferring patient data to a second physician, for example, as allowed by the “continuity of care” provision of HIPAA. Under this provision in a situation where a first physician can not provide care to the patient, the first physician can transfer the care of that patient to a second physician until the first physician can resume providing care. To transfer the patent data, the second physician can send the second physician's user ID to the first physician. The first physician can log into the first physician account on the server 6, as described supra. The first physician can then select to transfer patient data on the server, within the first physician account. The first physician can then designate the specific patient data/record and the second physician's user ID. The server 6 can then encrypts the designated patient record with the second physician's physician data public key. The server 6 can then add the designated patient data to the second physician account.

In one embodiment, a physician's device security application, such as a software program written in javascript, can execute on the physician's device 4, for example within a web browser, or as a stand-alone program. The physician's device security application can compute the login hash and send only the hash, for example without the stand-alone encrypted or unencrypted password, to the server 6. The server 6 can send the encrypted private key to the physician's device 4. The physician's device 4 can use the physician's device security application to decrypt the encrypted physician data private key, for example in the RAM of the physician's device 4. The server 6 can send patient data to the physician's device 4 only in encrypted form, and the physician's device security application can decrypt the patient data. If the patient is transferred from a first physician to a second physician, the server 6 can send the first physician's device the second physician's physician data public key to encrypt the patient data, and the first physician's device can encrypt the patient data using the second physician's physician data public key and send the encrypted patient data directly to the second physician's device.

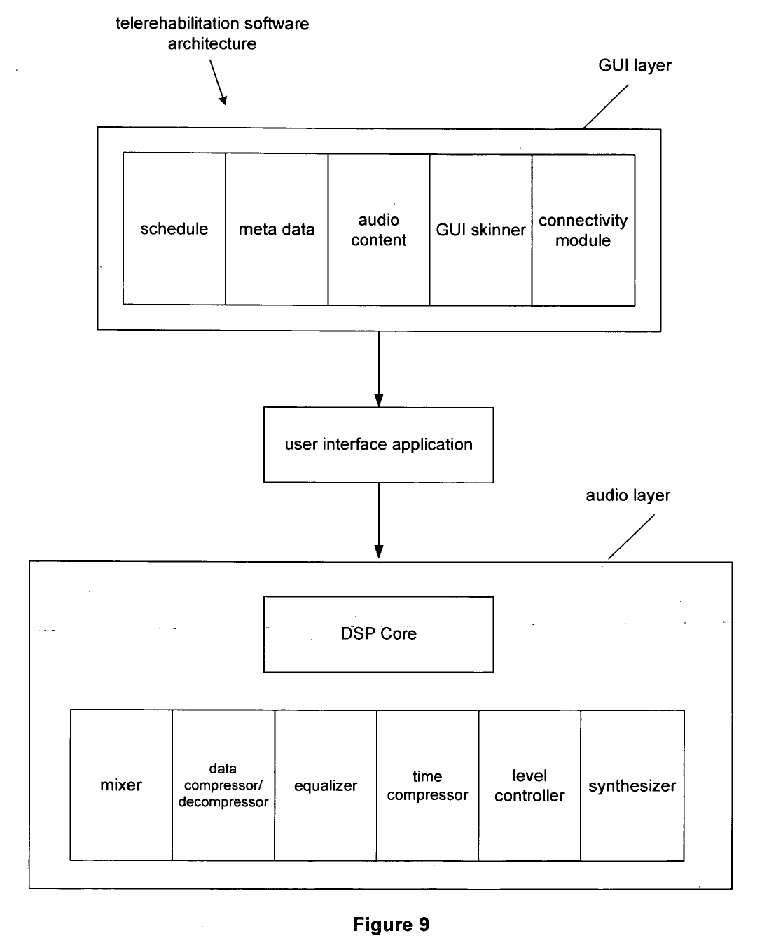

FIG. 9 illustrates that the patient's device's software architecture can have a graphical user interface (GUI) layer, a user interface application, and an audio layer. The patient's device architecture can be hardware architecture, software architecture or a combination thereof.

The GUI layer can drive the user interface application. Input entered via the user interface application and/or the GUI layer can drive the audio layer.

The GUI layer can have a schedule, meta data, media (e.g., audio and/or video) content, one or more GUI skinners, a connectivity module, and combinations thereof. The patient and/or patient's device 8 can use the schedule to determine when to run a telerehabilitation exercise. The meta data can be, for example, the text of the audio component of the media content. The GUI skinners can provide attractive and/or functional faces on the visible GUI of the telerehabilitation application. The connectivity module enables the user interface application to communicate with the GUI layer, and/or for the GUI layer to communicate with any other elements of the system 2.

The GUI layer can deliver GUI layer data to the user interface application. The GUI layer data can include the schedule and telerehabilitation meta data and media content. The user interface application can deliver the GUI layer data and additional user commands to the audio layer.

The GUI layer can have one or more settings. Each setting can be pre-included or can be added via an expansion module. Each setting can be particular to a particular subject preference. For example, one setting can be tailored to children (e.g., cartoon animals, bubble letters), one setting can be tailored to a non-English character language (e.g., katakana and hiragana alphabets), one setting can be tailored to English speaking adults, one setting can be tailored to autistic children. The setting of the GUI layer can be changed or kept the same for each use of the system 2.

The media data or content can include audio files, video files, image files, text files, or combinations thereof. The schedule can include schedules for training including which modules, which characteristics (e.g., phonemes, sibilance), other training delivery data, or combinations thereof.

Video displays can be used in conjunction with audio to train, for example, for lip reading.

The audio layer can have a digital signal processing (DSP) core, mixer, data compressor and decompressor, equalizer, time compressor, level controller, synthesizer (e.g. voice, sound, FM, convolutional, additive), a volume compressor/expander (dynamics) engine (not shown), and combinations thereof. The mixer, data compressor and decompressor, equalizer, time compressor, level controller, synthesizer, dynamics engine, and combinations thereof can be components of the DSP core.

The DSP core can be configured to process the media content, including audio and/or video data, and/or some or all of the schedule and/or meta data. The DSP core can interact with one or more functions. The DSP core can communicate with one or more components. The components can be functions within, or executed by, the DSP core, separate programs, or combinations thereof.

The audio layer can use the DSP core to emulate environments or audio transmission technologies (e.g., a convolution reverberation that can emulate acoustic spaces, echo and/or equalizing effects).

The audio layer can use the DSP core to generate and/or emulate spatial localization technologies (e.g. surround sound, multiple channel outputs for locating a sound source in three dimensional space).

The DSP core can process the media content (i.e., data). The processing can include mixing the audio data with noise, time delaying, distorting such as time compressing, equalizing, echoing, modulating, volume changing such as fading in and/or fading out, pitch shifting, phase shifting, modulating (e.g. amplitude, frequency, phase or combinations thereof), synthesis (e.g. voice and sound), chorusing, flanging, increasing and/or decreasing sample rate, reverberating, sustaining, shifting from one-channel to another such as panning, high-pass and/or low-pass and/or band-pass filtering, otherwise altering as needed by the module, or combinations thereof.

The terms “on the fly” or “real time” are defined as being performed in the present, near future or concurrent with or substantially immediately following other critical operations, such as computing a subject's result. The DSP core and/or audio layer can process the media data on the fly.

The synthesizer can be configured to create new multimedia files. The new multimedia files can be created, for example, by recording audio and/or video samples, and by using methods known to those having ordinary skill in the art to create new multimedia files using the samples. The synthesizer can record samples of a non-familiar or a familiar voice and/or image to the intended recipient of the treatment, training or testing, for example the voice or image of the intended recipient's spouse or friend. The synthesizer can be configured to create output samples closely approximating human speech from text input data.

The dynamic engine can create dynamic effects, for example environmental effects, in the media content. The dynamic engine can create reverberation in audio output. The reverberation can simulate sound echoing, for example, in a large or small room, arena, or outdoor setting.

The dynamic engine can tune and/or optimize (e.g., tone control) the speakers, for example, for the local environment. A microphone can be used to detect a known sample of audio output played through the speakers. The dynamic engine can analyze the detected sample input through the microphone. The analysis by the dynamic engine can be used to alter the audio output, for example, to create a flat frequency response across the frequency spectrum.

The dynamic engine can create artificial acoustic environments (e.g., office, tank, jet plane, car in traffic).

The dynamic engine and/or equalizer can adjust the characteristics of the audio output (e.g., gain of frequency range, reverberation) based on audio received during the subject's response to the training. The characteristics of the audio output can be continuously or occasionally adjusted, for example, to accommodate for room size and frequency response.

The mixer can combine multiple sounds with individual gains. The mixer can combine noise with the media content. The mixer can combine a cover-up sound (e.g., another word, a dog barking, a crash, silence) with the multimedia output such that a target sound (e.g., a target word in a cognitive training exercise) is covered by the cover-up sound. The mixer can increase and/or decrease the gain of the noise and, separately or together, increase and/or decrease the gain of the media content output.

The data compressor and/or decompressor can be configured to compress and/or decompress any files used by the DSP core. The data compressor and/or decompressor can decompress input data files and/or compress output data files in format such as SPEEX, MPEG-3, MPEG-4, AAC or AC-3.

The DSP core can download and/or upload files over the network 10. The compressor and/or decompressor can compress and/or decompress files before and/or after the files are uploaded and/or downloaded. The DSP core can use surround sound, for example to locate competing speakers in any combination of: in front, beside, and behind the patient. The DSP core can use surround sound, for example, to surround the user in babble.

The equalizer can be configured to control the gain of sound characteristics ranges individually, in groups, or for the entirety of the audio output. The sound characteristics ranges can include frequency, phonemes, tones, or combinations thereof. The equalizer can be configured to process audio output through a head-related transfer function (HRTF). The HRTF can simulate location-specific noise creation (e.g., to account for sound pressure wave reflections off of the geometry of the ears).

The time compressor can be configured to increase and/or decrease the rate of the media data output. For example, the time compressor can alter the rate of audio output with or without altering the pitch of the audio output.

The system 2 can have one or more external transducers. The external transducers can be audio transducers and emit sound. For example the external transducers can be speakers and/or microphones. The external transducers can sense ambient conditions and can have one or more biometric sensors, such as biometric sensor strips and/or biometric sensor pads. The biometric sensors can be configured to sense body temperature, pulse (i.e., heart rate), perspiration (e.g., by galvanic skin response or electrodermal response), diastolic, systolic or average blood pressure, electrocardiogram (EKG), brain signals (e.g., EEG, such as EEG used to determine sensory threshold audio levels, auditory event-related potentials (ERP)), hematocrit, respiration, movement and/or other measures of activity level, blood oxygen saturation and combinations thereof. The biometric sensors can be electrodes, pressure transducers, bimetallic or thermister temperature sensors, optical biometric sensors, or any combination thereof. The sensors external transducers can sense noise/sound, temperature, humidity, light, and/or be used to record verbal notes. The patient's device 8 can store in the patient's device's memory signals detected by the sensors and transducers of the patient's device 8. The sensor and transducer data can be stored with time stamp data, for example in the database 9.

It is apparent to one skilled in the art that various changes and modifications can be made to this disclosure, and equivalents employed, without departing from the spirit 9 and scope of the invention. Furthermore, synonyms are used throughout this disclosure and are not intended to be limiting. For example, the subject can be equivalent to the patient.

Although physician and physician's device are used throughout the specification, these are exemplary species of a dispenser and a dispenser's device, respectively. The dispenser can be a physician, an audiologist, a speech pathologist, a neurologist, or any other dispenser of rehabilitation or training.

Although telerehabilitation and rehabilitation are used throughout the specification, these can be substituted for any auditory training and/or auditory rehabilitation.

Numerous species are used as specific examples in lieu of the genus, but any species of that genus disclosed herein can be substituted for the specific example species listed. For example, telerehabilitation, rehabilitation, treatment, training, teaching, augmentation, diagnosis, evaluation, and exercising are non-limitingly used interchangeably within this description.

All architectures listed herein can be software and/or hardware. Furthermore, referring to an action performed by hardware implies that software that the hardware is executing or otherwise using could be directly performing the action (e.g., the operating system, or other executables, directly).

The physician and the physician's device 4 can be interchanged throughout this disclosure. Field and object can be interchanged throughout this disclosure. The patient and the patient's device 4 can be interchanged throughout this disclosure. Elements shown with any embodiment are exemplary for the specific embodiment and can be used on other embodiments within this disclosure.

We claim:

1. A system for aural rehabilitation for a subject comprising:
a patient's device, and
a server, wherein the patient's device is securely networked with the server.

2. The system of claim 1, further comprising a physician's device, wherein the physician's device is securely networked with the server.

3. The system of claim 1, wherein the patient's device is configured to create a result and the result is uploaded to the server.

4. A method of aural rehabilitation for a subject comprising:
uploading a result to a server,
encrypting the result.

5. The method of claim 4, wherein before uploading, the method comprises calculating the result using a patient's device.

6. The method of claim 5, further comprising storing the result in a database.

7. The method of claim 6, wherein the server comprises the database.

8. The method of claim 6, wherein the result is stored in a physician's account within the database.

9. The method of claim 8, wherein the physician's account is secure.

10. The method of claim 8, wherein the result is stored in a patient's account within the physician's account.

11. The method of claim 10, wherein the patient's account is secure.

12. The method of claim 4, further comprising logging into a password-protected account.

13. The method of claim 4, wherein before uploading, the method comprises securely networking a first device to a second device.

14. The method of claim 4, wherein encrypting further comprising encrypting with public private key encryption.

15. The method of claim 4, further comprising validating an uploading device.

16. The method of claim 15, wherein validating comprises wherein the uploading device sends an identifying data, and wherein the identifying data comprises a device-specific identification.

17. The method of claim 4, further comprising storing a log-in hash value.

18. A method of securely distributing telerehabilitation software to a user comprising:
delivering the telerehabilitation software to a distributor,
reserving a license for the telerehabilitation software,
delivering the telerehabilitation software to the user,
activating the telerehabilitation software, wherein the user prompts the activation.

19. The method of claim 18, wherein reserving comprises connecting a first device to a second device over a secure network connection.

20. The method of claim 18, wherein activating comprises connecting a first device to a second device over a secure network connection.
